(19) United States
(12) Patent Application Publication
(10) Pub. No.: US 2009/0222853 A1
(43) Pub. Date: Sep. 3, 2009

(54) Advertisement Replacement System

(75) Inventors: Scott Anthony White, Austin, TX (US); James Leonard Cansler, Cedar Park, TX (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 12/040,460

(22) Filed: Feb. 29, 2008

(51) Int. Cl. H04N 7/10

(52) U.S. Cl. 725/34

(57) ABSTRACT

An advertisement replacement system monitors a multimedia stream containing digital television content and advertisements for indicators of objectionable advertisement content. Replacement content is substituted for all or part of an advertisement that has at least one indicator (or a threshold level) of objectionable content. Analysis of stored content may also be performed and stored objectionable content may be replaced with approved content. Blank screens, user-provided photographs, user-provided videos, advertiser-provided still images, and substitute advertisements are examples of replacement content.

### BACKGROUND

1. Field of the Disclosure

The present disclosure generally relates to distributing digital television content and more particularly to replacing advertisements associated with digital television content.

2. Description of the Related Art

Advertisements are commonly included as part of television content that may be received over a provider network. For some audiences, certain advertisements have objectionable content such as references to adult-oriented prescription medications or other products. In some cases, advertisements have objectionable content in that they target children for unhealthy products.

### BRIEF DESCRIPTION OF THE DRAWINGS

FIG. 1 depicts an example provider network in which advertisements are replaced in accordance with disclosed embodiments if the advertisements contain one or more indications of objectionable content;

FIG. 2 depicts, in block diagram form, selected elements of an embodied set-top box enabled for replacing advertisements detected to have objectionable content;

FIG. 3 depicts, in block diagram form, selected software-based applications for detecting and replacing objectionable advertisement content; and

FIG. 4 is a flow diagram with selected operations for detecting and replacing objectionable advertisement content.

### DESCRIPTION OF THE EMBODIMENT(S)

In one aspect, in a digital television environment an advertisement replacement system operates to substitute objectionable advertisement content with replacement content. The system includes a content detection module for sensing objectionable advertisement content. The system further includes a replacement module for automatically substituting replacement content for a portion of the objectionable advertisement content. Some embodied systems further include an advertisement detection module for detecting the beginning of an advertisement for monitoring by the content detection module. In some embodiments, the replacement content includes user-provided photographic images or user-provided video images. The content detection module may operate to compare closed-caption text to known words associated with objectionable content. In addition, the content detection module may review metadata associated with an advertisement for a rating that qualifies the advertisement as having objectionable content according to stored user profiles. Data related to classifying objectionable content may be received by the system through an input. In turn, the content detection module may access the received data for sensitivity data and other parameters related to detecting and replacing objectionable advertising content.

In another aspect, a method is disclosed for replacing advertisements that have indicators of objectionable content. The method may include detecting an advertisement in a multimedia stream. The method includes monitoring advertisements for one or more indicators of objectionable content. In response to detecting one or more indicators of objectionable content, the method includes substituting a portion of the advertisement with replacement content. In some embodiments, the replacement content includes user-provided photographic images or user-provided video images. Monitoring the advertisement for the one or more indicators of objectionable content may include comparing closed-caption text and known words that are stored and associated with objectionable content. In addition, monitoring the advertisement for an indicator of objectionable content may include reviewing metadata associated with the advertisement for a rating that qualifies the advertisement as having objectionable content according to stored user profiles. The content detection module may access user data stored in user profiles for sensing objectionable advertisement content. The method may further include buffering a multimedia stream that includes the advertisement content and inserting the replacement content in the buffer if an indicator of objectionable content is detected. Substituting replacement content for a portion of the advertisement may include replacing the entire advertisement. In the alternative, the method may include presenting a non-objectionable portion of the advertisement prior to substituting the replacement content for the objectionable portion.

In still another aspect, a set-top box is enabled for replacing advertisements received within a multimedia stream that includes digital television content. Embodied set-top boxes include an input for receiving the multimedia stream that contains the digital television content. Embodied set-top boxes further include a content detection module for detecting indicators of objectionable content in advertisements. Further, embodied set-top boxes include or are communicatively coupled to replacement modules for substituting approved content for a portion of the objectionable content. Some embodied set-top boxes further include an advertisement detection module for detecting the beginning of advertisements in the multimedia stream. In order to detect indicators of objectionable content, the content detection module may monitor metadata, closed-caption data, or speech data generated from speech recognition operations that monitor audio portions of the multimedia stream. Approved content for substituting may include user-provided photographic images.

The following description includes examples and details to enable one of ordinary skill in the art to practice the claimed subject matter without undue experimentation. It should be apparent to a person of ordinary skill that disclosed embodiments are included as examples and not exhaustive of all possible embodiments. Regarding reference numerals used to describe some elements in the figures, a hyphenated form of a reference numeral may refer to a specific instance of an element and the un-hyphenated form of the reference numeral may refer to the element generically or collectively. Thus, for example, “set-top box 121-1” refers to an instance of a set-top box. Accordingly, multiple set-top boxes may be referred to collectively as “set-top boxes 121” or “STBs 121.” In addition, using this numbering convention, a single set-top box may be referred to more generically as “set-top box 121” or “STB 121.”

In accordance with disclosed embodiments, any of several methods may be used to determine when an advertisement has or may have objectionable content. In some embodiments, advertisements may be manually “tagged” by user input (e.g., from remote control device inputs) and subsequently blocked during future broadcasts of the advertisement. In addition, user profiles may be configured to set user-defined criteria that are stored in user profiles and accessed when determining whether indicators exist for blocking commercials. Closed-caption data, speech recognition, optical character recognition, and other forms of processing may be conducted on multimedia streams to detect indicators for objectionable content. If a threshold level of objectionable content is met, the advertisement may be replaced, edited, or blocked to prevent the objectionable content from reaching viewers. Multimedia streams containing potentially objectionable content may be buffered and processed or alternatively, processed in substantially real time. In addition, any multimedia content stored on a digital video recorder (DVR), for example, may be processed during recording the content or after recording the content during non-peak times.

Some advertisers will obviously object to having their content removed from digital television content. Therefore, service provider networks may wish to implement embodied systems and methods in ways that do not conflict, in general, with the aims of the advertising industry. To this end, objectionable advertisements may be substituted with more appropriate advertisements rather than wholly blocking the advertisements. In other cases, methods and systems may block only the objectionable advertising or replace only the objectionable content with still images of user-provided photographs or video images of user-provided videos, as examples.

In some embodied systems, a service provider network delivers advertising content to a set-top box with advertisements that include advertisement ratings data within metadata. The metadata may also signal the beginning of the advertisement. The ratings data may be based on community-based groups or central ratings organizations, as examples. In some embodiments, advertisements have unique identifiers and a user is provided an opportunity to “tag” the advertisement for future blocking. In such systems, locally stored identification data may be compared to the identification data of incoming advertisements to determine whether the advertisement is approved or subject to replacement or blocking. In some embodiments, advertisements may be broadcast with tags that designate the advertisement as having a predetermined type of content. For example, advertisements may be tagged with one or more of a set of predetermined tags such as TV-Y, TV-G, TV-14, TV-MA, and the like. In operation, embodied set-top boxes or network-based equipment may detect these ratings by processing metadata that contains these tags. Alternatively, closed-caption data may be scanned for keywords the user has explicitly defined (e.g., Viagra) or compared against pre-defined profiles (e.g., a young child's profile that filters out certain keywords). In some embodiments, users may block further viewings of specific advertisements or advertisements by certain advertisers.

Once an objectionable advertisement is detected, in some embodiments, set-top box substitutes a more acceptable form of media for the duration of the advertisement. Options include simply “blacking out” the media or substituting media from the user's library (e.g., a snippet from a home video or an impromptu slideshow of random photos and a selection from the user's music library). In addition, advertiser-friendly options for replacing objectionable advertisements include substituting an advertiser-specific still image for the advertisement or substituting a simulcast or pre-staged alternate advertisement (e.g., a more acceptable edit or an advertisement for a different product from the same advertiser). Such advertisements may provide opportunities for advertisers to provide alternate advertisements that are more appropriate to an audience rather than simply having advertisements blocked and replaced with a blank screen, for example.

Embodied systems may provide parents with desired control over their children's viewing experience. In addition, advertisements that some users may find offensive or annoying may be blocked. For example, some adults would rather not see advertisements for products or services they already have. Providing substitute advertisements in such cases may reduce annoyance caused to the users and perhaps enhance an advertiser's chance of promoting and selling other products or services to the user. In some embodiments, a service provider network may generate revenue by allowing a user, as a premium service, the option to block or substitute offensive or annoying advertisements. Therefore, embodied systems for advertisement substitutions provide various solutions for presenting advertisements that are more effective and less objectionable.

Disclosed embodiments relate to substituting advertisements that may be included with or embedded within television programs, video-on-demand (“VOD”) programs, radio programs, and a variety of other multimedia content forms. In this disclosure terms such as “digital television content” or “multimedia program” may be used to describe any of these types of content. Suitable types of networks that may be provisioned for distribution and delivery of such multimedia content include, as examples, telephony-based networks, coaxial-based networks, satellite-based networks, and the like. In some networks that includes, for example, traditional coaxial-based “cable” networks, a service provider distributes a mixed signal that may include a relatively large number of multimedia content channels. Each channel may be transmitted at a different frequency band (i.e., channel), through a coaxial cable, a fiber-optic cable, or a combination of these and potentially other cables or wireless media. The enormous bandwidth required to transport simultaneously large numbers of multimedia channels is a source of constant challenge for cable-based providers. In these types of networks, a tuner or some form of receiver is required to select a channel from the mixed signal for playing or recording. Accordingly, a user wishing to play or record multiple channels simultaneously may need distinct tuners for each desired channel. This is an inherent limitation of cable networks and other mixed signal networks.

In contrast to mixed signal networks, internet protocol television (IPTV) networks generally distribute content to a user only in response to user requests. Therefore, at any given time, the number of content channels provided to the user is relatively small. For example, a user may simultaneously receive one or more multimedia streams that contain one channel for viewing and possibly one or more channels for recording during viewing of the first channel. As suggested by the name, IPTV networks typically employ IP and other open, mature, and pervasive networking technologies. During transmission, rather than requiring the use of a particular frequency band, an IPTV television program, movie, or other form of multimedia content is a digital, packet-based stream that corresponds to a particular network address (e.g., an IP address). In such networks, the concept of a channel is inherently distinct from the frequency channels native to mixed signal networks. Moreover, whereas a mixed signal network may require a hardware-intensive tuner for every channel to be played, IPTV channels can be “tuned” simply by transmitting a request (e.g., a universal resource locator (URL) request) to a server.

To transmit multimedia content, IPTV service providers may utilize existing infrastructure such as existing telephone lines. In addition, within a user's site (e.g., home or office), an IPTV service provider may utilize customer premises equipment (CPE), a residential gateway (RG), a digital subscriber line (DSL) modem, or other equipment enabled for receiving multimedia content and data from the provider network. Such CPE may include set-top boxes (STBs), displays, and other appropriate equipment for converting the received multimedia content into usable form. In some implementations, a core portion of an IPTV network is implemented with fiber optic cables, while the so-called “last mile” may include conventional, unshielded, twisted-pair, copper cables (e.g., traditional telephone lines).

Typical IPTV networks support bidirectional (i.e., two-way) communication between a user's CPE and the content provider's equipment. Bidirectional communication allows the content provider (i.e., “service provider” or “provider network”) to deploy advanced features, such as VOD, pay-per-view, electronic programming guides (“EPGs”), and the like. Bidirectional networks may also enable a service provider to collect information related to a user's preferences, viewing habits, and the like. In accordance with disclosed embodiments, bidirectional communication permits a user to provide inputs to network-based systems to request blocking replacement of objectionable advertisements. The bidirectional nature of the IPTV network also allows software applications related to the control of multimedia access to be network-based. In addition, communication between STBs over the provider network is permitted due to the bidirectional nature of an IPTV provider network. In this way, for example, a parent in one room may manipulate settings stored in an STB in another room (e.g., a child's room) to block objectionable advertisements.

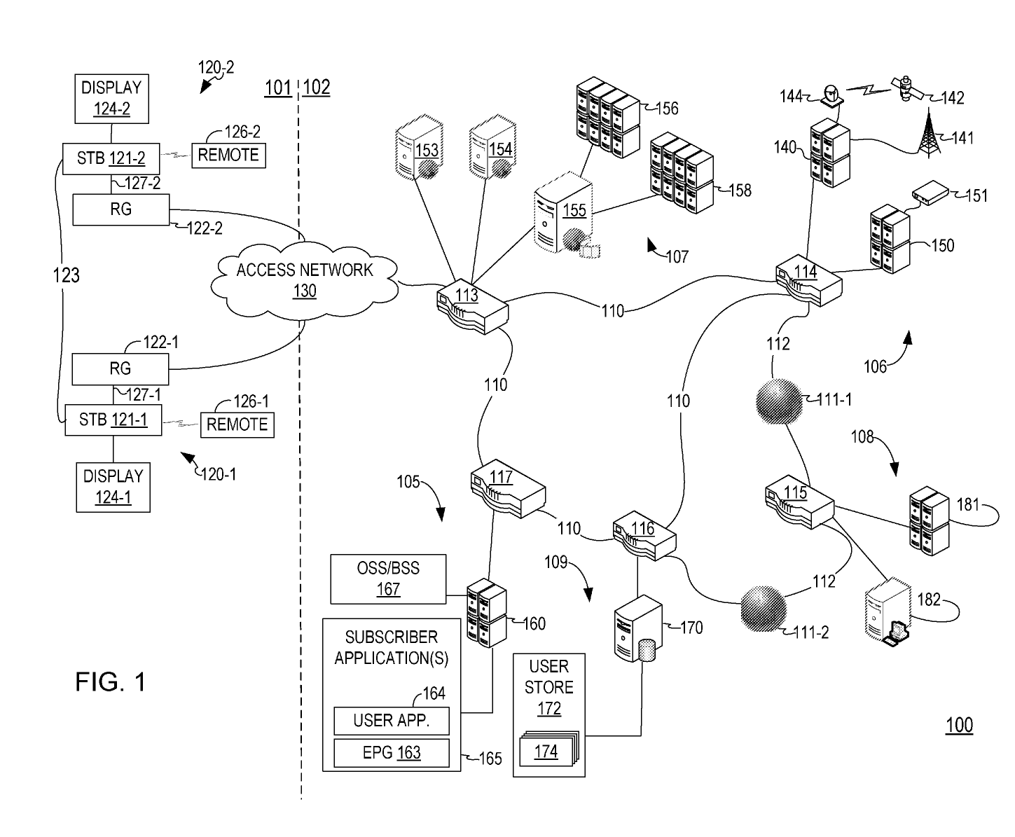

Additional details of embodied systems and methods are included in the attached drawings. FIG. 1 depicts selected aspects of a multimedia content distribution network (MCDN) 100. MCDN 100 is a provider network that, as shown, may be divided into a client side 101 and a service provider side 102 (a.k.a. server side 102). The client side 101 includes all or most of the resources depicted to the left of access network 130 while the server side 102 encompasses the remainder.

Client side 101 and server side 102 are linked by access network 130. In embodiments of MCDN 100 that leverage telephony hardware and infrastructure, access network 130 may include the “local loop” or “last mile,” which refers to the physical wires that connect a user's home or business to a local exchange. In these embodiments, the physical layer of access network 130 may include twisted pair copper cables or fiber optics cables employed as either fiber to the curb (FTTC) or fiber to the home (FTTH).

Access network 130 may include hardware and firmware to perform signal translation when access network 130 includes multiple types of physical media. For example, an access network that includes twisted-pair telephone lines to deliver multimedia content to users may utilize DSL. In embodiments of access network 130 that implement FTTC, a DSL access multiplexer (DSLAM) may be used within access network 130 to transfer signals containing multimedia content from optical fiber to copper wire for DSL delivery to consumers.

In other embodiments, access network 130 may transmit radio frequency (RF) signals over coaxial cables. In these embodiments, access network 130 may utilize quadrature amplitude modulation (QAM) equipment for downstream traffic. In these embodiments, access network 130 may receive upstream traffic from a consumer's location using quadrature phase shift keying (QPSK) modulated RF signals. In such embodiments, a cable modem termination system (CMTS) may be used to mediate between IP-based traffic on private network 110 and access network 130.

Services provided by the server side resources as shown in FIG. 1 may be distributed over a private network 110. In some embodiments, private network 110 is referred to as a “core network.” In at least some embodiments, private network 110 includes a fiber optic wide area network (WAN), referred to herein as the fiber backbone, and one or more video hub offices (VHOs). In large-scale implementations of MCDN 100 private network 110 includes a hierarchy of VHOs.

A national VHO may deliver national content feeds to several regional VHOs. In turn, each regional VHO may include its own acquisition resources to acquire local content, such as from the local affiliate of a national network, and to inject the local content into the feeds. The regional VHOs may then deliver the local and national content for reception by users served by the regional VHO. The hierarchical arrangement of VHOs, in addition to facilitating localized or regionalized content provisioning, may conserve bandwidth by limiting the content that is transmitted over the core network and injecting regional content “downstream” from the core network.

As shown in FIG. 1, segments of private network 110 are connected together with a plurality of network switching and routing devices referred to simply as switches 113 through 117. The depicted switches include client facing switch 113, acquisition switch 114, operations-systems-support/business-systems-support (OSS/BSS) switch 115, database switch 116, and an application switch 117. In addition to providing routing/switching functionality, switches 113 through 117 preferably include hardware or firmware firewalls (not depicted) that maintain the security and privacy of network 110. Other portions of MCDN 100 communicate over a public network 112, including, for example, the Internet or other type of web network where the public network 112 is signified in FIG. 1 by the World Wide Web icons 111.

As shown in FIG. 1, the client side 101 of MCDN 100 depicts two of a potentially large number of client-side resources referred to herein simply as client(s) 120. Each client 120, as shown, includes an STB 121, an RG 122, a display 124, and a remote control device 126. Clients 120 may be in different user sites, for example houses that are in different cities.

As shown in FIG. 1, RGs 122 may include elements of broadband modems (e.g., DSL modems), as well as elements of Ethernet-compliant routers and/or access points that are suitable for communication over local area networks (LANs) 127. In some embodiments, STBs 121 may be uniquely addressable Ethernet compliant devices. In the embodiment depicted in FIG. 1, remote control device 126 communicates wirelessly with STB 121 using an infrared (IR) or RF signal. Display 124 may include any form of conventional frequency tuner and may contain all or part of the functionality and circuitry of RG 122 and STB 121.

In IPTV-compliant implementations of MCDN 100, clients 120 are operable to receive packet-based multimedia streams from access network 130 and process the streams for presentation on displays 124. In addition, clients 120 are network-aware systems that may facilitate bidirectional-networked communications with server side 102 resources to facilitate network-hosted services and features such as the substitution of objectionable advertisements. Because clients 120 are operable to process multimedia content streams while simultaneously supporting more traditional web-like communications, clients 120 may support or comply with a variety of network protocols including streaming protocols such as reliable datagram protocol (RDP) over user datagram protocol Internet protocol (UDP/IP) and web protocols such as hypertext transport protocol (HTTP) over transport control protocol IP (TCP/IP). The depiction in FIG. 1 of server side 102 emphasizes network capabilities including application resources 105, content acquisition resources 106, content delivery resources 107, and OSS/BSS resources 108. One or more of these resources may have access to database resources 109.

Before distributing multimedia content to viewers, MCDN 100 first obtains multimedia content from content providers. To that end, acquisition resources 106 encompass various systems and devices to acquire multimedia content, reformat it when necessary or desired, and process it for delivery to users over private network 110 and access network 130. Acquisition resources 106 may include, for example, systems for capturing analog and/or digital content feeds, either directly from a content provider or from a content aggregation facility. Content feeds transmitted via VHF/UHF broadcast signals may be captured by an antenna 141 and delivered to live acquisition server 140. Similarly, live acquisition server 140 may capture down-linked signals transmitted by a satellite 142 and received by parabolic dish 144. In addition, live acquisition server 140 may acquire programming feeds transmitted via high-speed fiber feeds or other suitable transmission means. Acquisition resources 106 may further include signal conditioning systems and content preparation systems for encoding content.

As depicted in FIG. 1, content acquisition resources 106 include a VOD acquisition server 150. VOD acquisition server 150 receives content from one or more VOD sources that may be external to the MCDN 100 including, as examples, discs represented by DVD player 151, or transmitted feeds (not shown). VOD acquisition server 150 may temporarily store multimedia content for transmission to a VOD delivery server 158 in communication with client-facing switch 113.

After acquiring multimedia content, acquisition resources 106 transmits acquired content over private network 110, for example, to one or more servers in content delivery resources 107. Prior to transmission, live acquisition server 140 may encode acquired content using, for example, MPEG-2, H.263, a Windows Media Video (WMV) family codec, or another suitable video codec. Acquired content may be encoded and composed to preserve network bandwidth and network storage resources and, optionally, to provide encryption for securing the content. VOD content acquired by VOD acquisition server 150 may be in a compressed format prior to acquisition and further compression or formatting prior to transmission may be unnecessary.

Content delivery resources 107 as shown in FIG. 1 are in communication with private network 110 via client facing switch 113. In the depicted implementation, content delivery resources 107 include a content delivery server 155 in communication with a live or real-time content server 156 and a VOD delivery server 158. For purposes of this disclosure, the use of the term “live” or “real-time” in connection with content server 156 is intended primarily to distinguish the applicable content from the content provided by VOD delivery server 158. The content provided by a VOD server may be referred to as time-shifted content to emphasize the ability to obtain and view VOD content substantially without regard to the time of day or the day of week.

Content delivery server 155, in conjunction with live content server 156 and VOD delivery server 158, responds to viewer requests for content by providing the requested content to the viewer. The content delivery resources 107 are, in some embodiments, responsible for creating video streams that are suitable for transmission over private network 110 and/or access network 130. In some embodiments, creating video streams from the stored content generally includes generating data packets by encapsulating relatively small segments of the stored content in one or more packet headers according to the network communication protocol stack in use. These data packets are then transmitted across a network to a receiver (e.g., STB 121 of client 120), where the content is parsed from individual packets and re-assembled into multimedia content suitable for processing by a STB decoder.

Viewer requests received by content delivery server 155 may include an indication of the content that is being requested. In some embodiments, this indication includes an IP address associated with the desired content. For example, a particular local broadcast television station may be associated with a particular channel and the feed for that channel may be associated with a particular IP address. When a user wishes to view the station, the user may interact with remote control device 126 to send a signal to STB 121 indicating a request for the particular channel. When STB 121 responds to the remote control signal, the STB 121 changes to the requested channel by transmitting a request that includes an IP address associated with the desired channel to content delivery server 155.

Content delivery server 155 may respond to a request for content by making a streaming video signal accessible STB 121 for conversion into usable form by display 124. Content delivery server 155 may employ unicast and broadcast techniques when making content available to a viewer. In the case of multicast, content delivery server 155 employs a multicast protocol to deliver a single originating stream to multiple clients. When a new user requests the content associated with a multicast stream, there may be latency associated with updating the multicast information to reflect the new viewer as a part of the multicast group. To avoid exposing this undesirable latency to the user, content delivery server 155 may temporarily unicast a stream to the requesting user. When the user is ultimately enrolled in the multicast group, the unicast stream is terminated and the user receives the multicast stream. Multicasting desirably reduces bandwidth consumption by reducing the number of streams that must be transmitted over the access network 130 to clients 120.

As illustrated in FIG. 1, a client-facing switch 113 provides a conduit between client side 101 and server side 102. Client-facing switch 113, as shown, is so-named because it connects directly to the client 120 via access network 130 and it provides the network connectivity of IPTV services to users' locations.

To deliver multimedia content, client-facing switch 113 may employ any of various existing or future Internet protocols for providing reliable real-time streaming multimedia content. In addition to the TCP, UDP, and HTTP protocols referenced above, such protocols may use, in various combinations, other protocols including real-time transport protocol (RTP), real-time control protocol (RTCP), file transfer protocol (FTP), and real-time streaming protocol (RTSP).

In some embodiments, client-facing switch 113 routes multimedia content encapsulated into IP packets over access network 130. For example, an MPEG-2 transport stream may be sent that includes a series of 188-byte transport packets. Client-facing switch 113, as shown, is coupled to a content delivery server 155, acquisition switch 114, applications switch 117, a client gateway 153, and a terminal server 154 that is operable to provide terminal devices with a connection point to the private network 110. Client gateway 153 may provide user access to private network 110 and the resources coupled thereto.

In some embodiments, STB 121 may access MCDN 100 using information received from client gateway 153. Subscriber devices may access client gateway 153 and client gateway 153 may then allow such devices to access the private network 110 once the devices are authenticated or verified. Similarly, client gateway 153 may prevent unauthorized devices, such as hacker computers or stolen STBs, from accessing the private network 110. Accordingly, in some embodiments, when an STB 121 accesses MCDN 100, client gateway 153 verifies user information by communicating with user store 172 via the private network 110. Client gateway 153 may verify billing information and user status by communicating with an OSS/BSS gateway 167. OSS/BSS gateway 167 may transmit a query to the OSS/BSS server 181 via an OSS/BSS switch 115 that may be connected to a public network 112. Upon client gateway 153 confirming user and/or billing information, client gateway 153 may allow STB 121 access to IPTV content, VOD content, and other services. If client gateway 153 cannot verify user information for STB 121, for example, because it is connected to an unauthorized twisted pair or RG, client gateway 153 may block transmissions to and from STB 121 beyond the private access network 130.

MCDN 100, as depicted, includes application resources 105, which communicate with private network 110 via application switch 117. Application resources 105 as shown include an application server 160 operable to host or otherwise facilitate one or more subscriber applications 165 that may be made available to system users. For example, subscriber applications 165 as shown include an EPG application 163. Subscriber applications 165 may include other applications including user applications 164. In addition to subscriber applications 165, application server 160 may host or provide a gateway to operation support systems and/or business support systems. In some embodiments, communication between application server 160 and the applications that it hosts and/or communication between application server 160 and client 120 may be via a conventional web based protocol stack such as HTTP over TCP/IP or HTTP over UDP/IP.

As shown in FIG. 1, application server 160 hosts a generic application referenced as user application 164. User application 164 represents any application that may deliver a value-added feature to a subscribing user or non-subscribing user. User application 164 is illustrated in FIG. 1 to emphasize the ability to extend the network's capabilities by implementing one or more networked-hosted applications. Because the application resides on the network, it generally does not impose any significant computing requirements on local devices or imply any substantial modifications to the client 120 including STB 121. In some instances, an STB 121 may require knowledge of a network address associated with user application 164, but STB 121 and the other components of client 120 are typically largely unaffected. Accordingly, STBs that are not locally networked together may exchange information through user application 164 or may share information that is processed by one or more applications such as user application 164.

In accordance with disclosed embodiments, user application 164 may include software modules or applications for substituting objectionable advertisement content according to user preferences. The software modules may reside on computer-readable media that is network-based and communicatively coupled to or otherwise included with MCDN 100. Alternatively, parts of the software modules for substituting objectionable advertisements may reside on devices such as STBs 121. Therefore, in accordance with disclosed embodiments, MCDN 100 includes an advertisement replacement system for substituting replacement content for objectionable advertisement content. In some disclosed embodiments, user application 164 includes a content detection module for sensing objectionable content. The content detection module and other similar modules may include computer executable instructions and may be stored on computer readable media. User application 164 may further include a replacement module for automatically substituting replacement content for a portion of the objectionable advertisement content. In some embodiments the replacement content includes user-provided photographic images. User-provided photographic images may be stored on STB 121 or uploaded to network-based storage such as storage used for user profiles 174. In addition, replacement content may include user-provided video images as substitute content.

In some embodiments, for content that may be queued for delivery to STB 121, the content detection module operates to compare closed-caption text to known words associated with objectionable content. Alternatively, the content detection module may review metadata associated with an advertisement for a rating that qualifies the advertisement as having objectionable content according to predetermined parameters stored in a user profile. In some multimedia streams, the beginning of an advertisement may not be identified without an advertisement detection module. In some embodiments, user application 164 further includes or accesses an advertisement detection module for detecting the occurrence of an advertisement. Therefore, in other streams, the beginning of an advertisement may be bookmarked using metadata, out-of-band data, or packet headers as examples. In some embodiments, user application 164 receives an input or an indication of an input regarding which content to block as objectionable content. In such embodiments, the content detection module accesses the user preferences for setting sensitivity levels (i.e., threshold levels) for what should be blocked as objectionable. Embodied systems may include a buffer for processing a multimedia stream analyzed by the content detection module. Accordingly, multimedia content may be streamed through the buffer and analyzed. If objectionable content is detected or sensed, substitute content may be inserted within the buffer or otherwise displayed in place of the objectionable content. In some cases, substituting replacement content for the objectionable content includes replacing the entire advertisement. In other cases, non-objectionable parts of an advertisement are played until the replacement module or related component automatically substitutes replacement content for the objectionable advertisement content.

Additional elements shown in FIG. 1 include database switch 116, which is connected to applications switch 117 and provides access to database resources 109. Database resources 109 include a database server 170 that manages a system storage resource 172, also referred to herein as user store 172. User store 172, as shown, includes one or more user profiles 174 where each user profile includes account information and may include preferences information that may be retrieved by applications executing on application server 160 including subscriber application 165. MCDN 100, as shown, includes OSS/BSS resources 108 including an OSS/BSS switch 115. OSS/BSS switch 115 facilitates communication between OSS/BSS resources 108 via public network 112. The OSS/BSS switch 115 is coupled to an OSS/BSS server 181 that hosts operations support services including remote management via a management server 182. OSS/BSS resources 108 may include a monitor server (not depicted) that monitors network devices within or coupled to MCDN 100 via, for example, a simple network management protocol (SNMP).

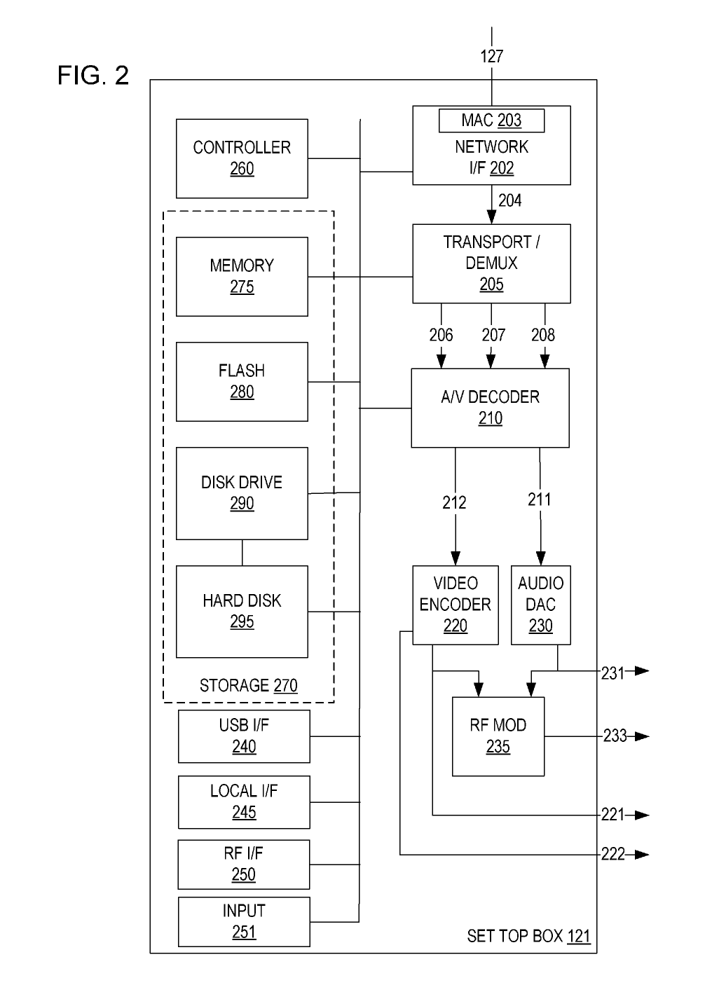

FIG. 2 depicts selected components of STB 121, which may be similar to or identical to STB 121 in FIG. 1. As shown, STB 121 (FIG. 2) is enabled to detect indicators of objectionable content in advertisements and replace the objectionable content with substitute content. As shown, STB 121 is suitable for use in an IPTV client and includes functionality in some combination of hardware, software, and firmware to receive streaming multimedia data from an IP-based network and process the data to produce video and audio signals suitable for delivery to an NTSC, PAL, or other type of display 124. In addition, some embodiments of STB 121 may include resources to store and play back multimedia content locally.

As shown in FIG. 2, STB 121 includes a general-purpose processing core represented as controller 260. Controller 260 communicates with special purpose multimedia modules including, as examples, transport/demultiplexer module 205, an A/V decoder 210, a video encoder 220, an audio digital-to-analog converter (DAC) 230, and an RF modulator 235. Although FIG. 2 depicts each of these modules discretely, STB 121 may be implemented with a system on chip (SoC) device that integrates controller 260 and each of these multimedia modules. In still other embodiments, STB 121 may include an embedded processor serving as controller 260 and at least some of the multimedia modules may be implemented with a general-purpose digital signal processor (DSP) and supporting software.

As shown in FIG. 2, input module 251 may operate to receive user preferences regarding what content to block as objectionable. Network interface 202 enables STB 121 to communicate with an external network such as LAN 127. Network interface 202 may share many characteristics with conventional network interface cards (NICs) used in personal computer platforms. For embodiments in which LAN 127 is an Ethernet LAN, for example, network interface 202 implements level 1 (physical) and level 2 (data link) layers of a standard communication protocol stack by enabling access to the twisted pair or other form of physical network medium and by supporting low level addressing using media access control (MAC) addressing. In these embodiments, every network interface 202 includes, for example, a globally unique 48-bit MAC address 203 stored in a read-only memory (ROM) or other persistent storage element of network interface 202. Similarly, at the other end of the LAN connection 127, RG 122 (FIG. 1) has a network interface (not depicted) with its own globally-unique MAC address.

Network interface 202 may further include or support software or firmware providing one or more complete network communication protocol stacks. Where network interface 202 is tasked with receiving streaming multimedia communications, for example, network interface 202 may include a streaming video protocol stack such as an RTP/UDP stack. In these embodiments, network interface 202 is operable to receive a series of streaming multimedia packets and process them to generate a digital multimedia stream 204 that is provided to transport/demux 205.

As shown in FIG. 2, STB 121 carries and processes digital multimedia stream 204, which in accordance with disclosed embodiments contains a multimedia program and may contain objectionable advertisement content. The digital multimedia stream 204 is a sequence of digital information that includes interlaced audio data streams and video data streams. The video and audio data contained in digital multimedia stream 204 may be referred to as “in-band” data in reference to a particular frequency bandwidth that such data might have been transmitted in an RF transmission environment. Digital multimedia stream 204 may also include “out-of-band” data that might encompass any type of data that is not audio or video data, but may refer in particular to data that is useful to the provider of an IPTV service (e.g., advertisement rating data). This out-of-band data might include, for example, billing data, decryption data, and data enabling the IPTV service provider to manage IPTV client 120 remotely. In some embodiments, advertisement rating data or substitute content data may be transmitted as out-of-band data and otherwise excluded from the core audio or video portions of digital multimedia stream 204.

Transport/demux 205, as shown, is operable to segregate and possibly decrypt the audio, video, and out-of-band data in digital multimedia stream 204. Transport/demux 205 outputs a digital audio stream 206, a digital video stream 207, and an out-of-band digital stream 208 to A/V decoder 210. Transport/demux 205 may also, in some embodiments, support or communicate with various peripheral interfaces of STB 121 including RF interface 250 suitable for use with an RF remote control device (not shown) and a front panel interface (not shown). RF interface 250 may also be compatible to receive infrared signals, light signals, laser signals, or other signals from remote control devices that use signal types that differ from RF signals. RF interface 250 represents a hardware interface that may be enabled for receiving signals indicative of user inputs. For example, a user may provide user inputs to a remote control device for selecting or highlighting EPG elements on a display or setting preferences regarding what should be considered objectionable content.

A/V decoder 210 processes digital audio, video, and out-of-band streams 206, 207, and 208 respectively to produce a native format digital audio stream 211 and a native format digital video stream 212. A/V decoder 210 processing may include decompression of digital audio stream 206 and/or digital video stream 207, which are generally delivered to STB 121 as compressed data streams. In some embodiments, digital audio stream 206 and digital video stream 207 are MPEG compliant streams and, in these embodiments, A/V decoder 210 is an MPEG decoder.

The digital out-of-band stream 208 may include information about or associated with advertisement content and digital television content provided through the audio and video streams. This information may include, for example, ratings, the title of a show, start and end times for the show, type or genre of the show, broadcast channel number associated with the show, and so forth. A/V decoder 210 may decode such out-of-band information. MPEG embodiments of A/V decoder 210 support a graphics plane as well as a video plane and at least some of the out-of-band information may be incorporated by A/V decoder 210 into its graphics plane and presented to display 124, perhaps in response to a signal from a remote control device. In addition to potentially including data related to blocked or substituted advertisement content, the digital out-of-band stream 208 may be a part of an EPG, an interactive program guide, or an electronic service guide (ESG). These devices allow a viewer to navigate, select, and search for content by time, channel, genre, title, and the like. A typical EPG may have a graphical user interface that enables the display of program titles and other descriptive information such as program identifiers, a summary of subject matter for programs, names of actors, names of directors, year of production, and the like.

As shown in FIG. 2, the native format digital audio stream 211 is routed to audio DAC 230 to produce an audio output signal 231. The native format digital video stream 212 is routed to an NTSC/PAL or other suitable video encoder 220, which generates digital video output signals suitable for presentation to an NTSC or PAL compliant display device. In the depicted embodiment, video encoder 220 generates a composite video output signal 221 and an S video output signal 222. An RF modulator 235 receives the audio and composite video output signals 231 and 221 respectively and generates an RF output signal 233 suitable for providing to an analog input of a display (e.g., display 124 from FIG. 1). STB 121, as shown, includes universal serial bus (USB) interface 240 and a local interconnection interface 245. Local interconnection interface 245 may, in some embodiments, support Home Phone Networking Alliance (HPNA) or another form of local interconnection 123 as shown in FIG. 1.

The illustrated embodiment of STB 121 includes storage resources 270 that are accessible to controller 260 and possibly one or more multimedia modules. Storage resources 270 may include dynamic random access memory (DRAM) or another type of volatile storage identified as memory 275 as well as various forms of persistent or nonvolatile storage including flash memory 280 and/or other suitable types of persistent memory devices including ROMs, erasable programmable read-only memory (EPROMs), and electrical erasable programmable read-only memory (EEPROMs). In addition, the depicted embodiment of STB 121 includes a mass storage device in the form of one or more magnetic hard disks 295 supported by integrated device electronics (IDE) compliant or other type of disk drive 290. Embodiments of STB 121 employing mass storage devices may be operable to store content locally and play back stored content when desired. In addition, one or more components of storage resources 270 may be employed to store program identification data, user preferences, administrator preferences, and the like for operation of disclosed embodiments.

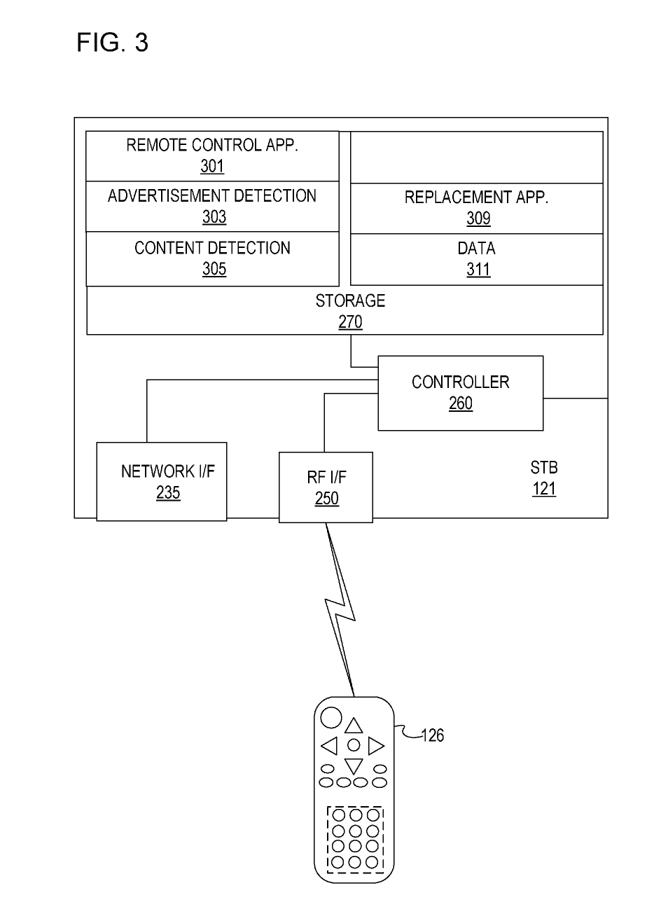

FIG. 3 illustrates STB 121, which has selected software elements or modules (e.g., software applications) operable for detecting and replacing objectionable advertisement content, in accordance with some embodiments. In the depicted implementation, storage resources 270 include programs or execution modules identified as remote control application 301, advertisement detection 303, content detection 305, and replacement application 309. In addition, the depicted implementation of storage 270 includes data 311. Network interface 235 is enabled for allowing STB 121 communication with remote sources such as other STBs and Internet based servers, as examples.

Remote control application 301 includes computer executable code that supports STB 121's remote control functionality. For example, when a viewer depresses a volume button on remote control device 126 (FIG. 1), remote control application 301 is invoked by controller 260 in response to a signal from RF I/F 250 indicating that RF I/F 250 has received a remote control command signal. Although the embodiments described herein employ a wireless remote control device 126 to convey viewer commands to STB 121, the viewer commands may be conveyed to STB 121 in other ways. For example, STB 121 may include a front panel having function buttons that are associated with various commands, some of which may coincide with commands associated with function buttons on remote control device 126. Similarly, although remote control device 126 is described herein as being an RF or IR remote control device, other embodiments may use other media and/or protocols to convey commands to STB 121. For example, remote control commands may be conveyed to STB 121 via USB, WiFi (IEEE 802.11-family protocols), and/or Bluetooth techniques, all of which are well known in the field of network communications. RF I/F 250 may be operable to parse or otherwise extract the remote control command that is included in the signal. The remote control command may then be made available to controller 260 and/or remote control application 301. In this manner, remote control application 301 may receive an indication of the remote control command from the RF I/F 250 directly or from controller 260. In the latter case, for example, controller 260 may call remote control application 301 as a function call and include an indication of remote control device 126 as a parameter in the function call.

As shown, a content detection application 305 detects indicators of objectionable content in advertisements that are included within a multimedia stream. Replacement application 309 substitutes approved content for a portion of the advertisement. Advertisement detection application 303 detects advertisements in a multimedia stream. An advertisement may be detected by analyzing screenshots, analyzing changes in audio portions of a multimedia stream, analyzing metadata associated with a multimedia stream, analyzing closed-caption text, or processing headers for packets that make up a multimedia stream, as examples. In addition, speech recognition may be performed on an audio portion of a multimedia stream to detect indicators of objectionable content. The examples listed for detecting advertisements and objectionable content are for illustration purposes only and are not meant to limit the claimed subject matter.

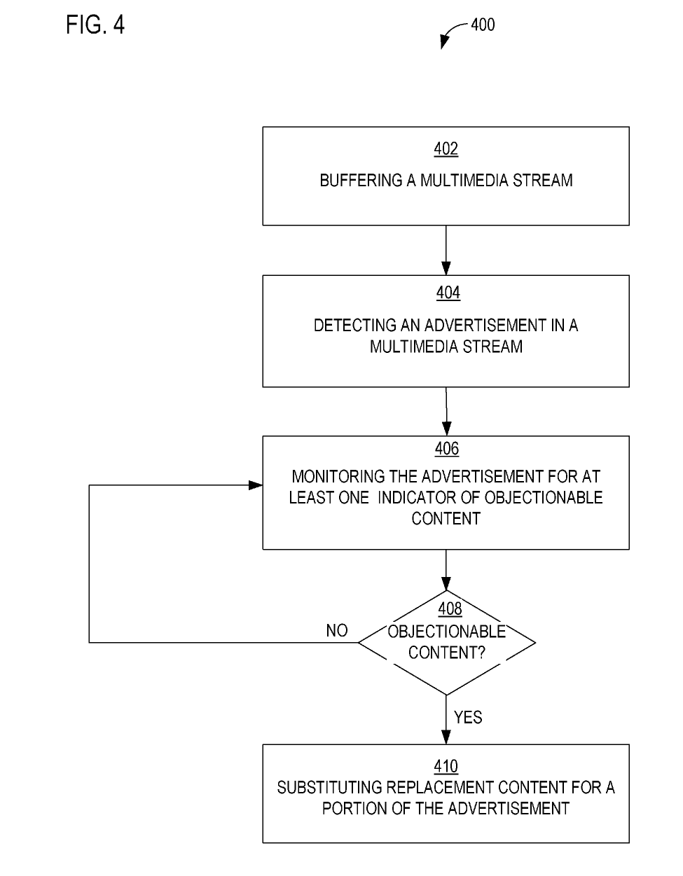

FIG. 4 illustrates methodology 400 for substituting objectionable advertisement content with user-specified content, replacement advertisements, or a blank display screen, as examples. As shown, optional operation 402 relates to buffering a multimedia stream. Operation 402 is optional in disclosed embodiments and may create a delay needed for processing a multimedia stream. While the multimedia stream is within the buffer, it may be analyzed for objectionable content. For example, metadata associated within the multimedia stream may be analyzed for words that indicate objectionable advertisement content. In addition, voice recognition may be performed on an audio portion of the multimedia stream to detect indications of objectionable advertisement content. Operation 404 relates to detecting an advertisement in the multimedia stream. In some embodiments, detecting the beginning of an advertisement may require processing of multimedia content or processing of metadata associated with the multimedia content. Advertisements may be marked with identifiers such as packet headers that are used in operation 404 for detecting the occurrence of an advertisement. Operation 406 relates to monitoring the advertisement for an indicator of objectionable content. In some cases, trigger words may provide an indication of objectionable content. Trigger words may be stored in a user profile in a local STB or remotely on an application server, as examples. Example trigger words include “sex,” “sexual performance,” “ED,” “condom,” “beer,” or “girls gone wild.” In addition or alternatively, operation 406 may be performed by comparing close-captioned text to known words associated with objectionable content. In addition, operation 406 may include processing metadata associated with the advertisement for a rating that qualifies the advertisement as having objectionable content. If a service network provider or advertiser sends advertisements with standardized ratings (e.g., PG-13), then the metadata may be analyzed for such indicators of objectionable content. Operation 408 makes a determination of whether monitored advertisements contain objectionable content. If no objectionable content is detected or until a threshold level of objectionable content is reached, methodology 400 cycles back to operation 406 as shown for more monitoring of advertisements for indicators of objectionable content. If a threshold level of objectionable content is found in operation 408, methodology 400 proceeds to operation 410 for substituting replacement content for a portion of the advertisement. In some embodiments, non-objectionable portions of an advertisement are displayed and objectionable portions of the advertisement are replaced or deleted. Replacement content may include user-provided photographic images, user-provided video images, edited versions of the objectionable advertisement, or substitute advertisements chosen by a service provider network, affiliate, or user.

While the disclosed systems may be described in connection with one or more embodiments, it is not intended to limit the subject matter of the claims to the particular forms set forth. On the contrary, disclosed systems are intended to include alternatives, modifications, and equivalents as may be included within the spirit and scope of the subject matter as defined by the appended claims. For example, although disclosed embodiments may be described in terms of STBs, it should be noted that disclosed embodiments may incorporate such functionality into data processing systems, displays, televisions, or monitors that do not have physical characteristics, for example, of traditional converter boxes that may have been operated from atop a television, as the name “set-top box” may otherwise suggest.

What is claimed is:

1. An advertisement replacement system for providing replacement content in place of objectionable advertisement content in a digital television environment, the system comprising:
a content detection module for determining whether an advertisement includes a threshold level of objectionable advertisement content; and
a replacement module for automatically substituting replacement content for at least a portion of the objectionable advertisement content.

2. The advertisement replacement system of claim 1, wherein the replacement content includes user-provided photographic images.

3. The advertisement replacement system of claim 1, wherein the replacement content includes user-provided video images.

4. The advertisement replacement system of claim 1, wherein said determining includes comparing closed-caption text to known words associated with objectionable content and associated with a user profile.

5. The advertisement replacement system of claim 1, wherein said determining includes module is for reviewing metadata associated with an advertisement for a rating that qualifies the advertisement as having objectionable content according to predetermined parameters.

6. The advertisement replacement system of claim 1, further comprising:
an advertisement detection module for detecting the occurrence of an advertisement for monitoring by the content detection module.

7. The advertisement replacement system of claim 1, further comprising:
a buffer for processing a multimedia stream analyzed by the content detection module, and wherein the buffer is further for receiving the replacement content when the advertisement includes the threshold level of objectionable advertisement content.

8. The advertisement replacement system of claim 7, wherein substituting replacement content for the objectionable advertisement content includes wholly replacing the advertisement.

9. The advertisement replacement system of claim 7, wherein an unobjectionable portion of the advertisement is played until the replacement module automatically substitutes replacement content for the portion of the objectionable advertisement content.

10. A method of replacing advertisements that have indicators of objectionable content, the method comprising:
detecting an advertisement in a multimedia stream;
monitoring the advertisement for at least one indicator of objectionable content; and
in response to detecting an indicator of objectionable content, substituting replacement content for at least a portion of the advertisement.

11. The method of claim 10, wherein the replacement content includes user-provided photographic images.

12. The method of claim 10, wherein the replacement content includes user-provided video images.

13. The method of claim 10, wherein monitoring the advertisement for at least one indicator of objectionable content includes comparing closed-caption text to stored words associated with objectionable content.

14. The method of claim 10, wherein monitoring the advertisement for at least one indicator of objectionable content includes reviewing metadata associated with the advertisement for a rating that qualifies the advertisement as having objectionable content according to a user profile.

15. The method of claim 10, further comprising:
buffering a multimedia stream that includes the advertisement; and
buffering the replacement content if an indicator of objectionable content is detected.

16. The method of claim 10, wherein substituting replacement content for a portion of the advertisement includes wholly replacing the advertisement.

17. The method of claim 10, further comprising:
playing a non-objectionable portion of the advertisement prior to substituting replacement content for an objectionable portion of the advertisement.

18. A set-top box enabled for replacing advertisements received with digital television content, the set-top box comprising:
an input for receiving a multimedia stream containing digital television content;
a content detection module for detecting at least one indicator of objectionable content in an advertisement included in the multimedia stream; and
a replacement module for including replacement content at least in portions of the multimedia stream that contain indicators of objectionable content.

19. The set-top box of claim 18, further comprising:
an advertisement detection module for detecting advertisements in the multimedia stream.

20. The set-top box of claim 18, wherein the replacement content includes user-provided photographic images.

21. The set-top box of claim 18, wherein the content detection module is for monitoring metadata associated with the multimedia stream to detect the indicator of objectionable content.

22. The set-top box of claim 18, wherein the content detection module is for monitoring closed-caption data associated with the multimedia stream to detect the indicator of objectionable content.

23. The set-top box of claim 18, wherein the content detection module is for performing speech recognition on audio data from the multimedia stream to detect the indicator of objectionable content.
